(19) United States
(12) Patent Application Publication
(10) Pub. No.: US 2010/0009166 A1
(43) Pub. Date: Jan. 14, 2010

(54) ELECTRET FINISH

(75) Inventors: Salah Bendjaballah, Saarbrucken (DE); Sylvia Klausnitzer, Bruckmuhl (DE)

Correspondence Address: Clements Bernard PLLC, 1901 Roxborough Road, Suite 250, Charlotte, NC, 28211, US

(73) Assignee: NANOGATE AG, Quierschied (DE)

(21) Appl. No.: 12/376,594

(22) PCT Filed: Sep. 10, 2007
(86) PCT No.: PCT/EP2007/059481

§ 371 Date: Mar. 3, 2009

(30) Foreign Application Priority Data
Sep. 8, 2006 (DE) 10 2006 042 843.9

(51) Int. Cl. B32B 5/16; B05D 3/14; H01F 1/01

(52) U.S. Cl. 428/323; 427/532; 252/62.51 R

(57) ABSTRACT

The invention relates to a dispersed electret finish, a process for preparing an electret coating, the electret coating resulting therefrom, and the use of the electret coating for finishing textiles and carpets or for preparing filters, for example, air and liquid filters or cigarette filters, sensors, condenser microphones, data memories or membranes.

The invention relates to a dispersed electret finish, a process for preparing an electret coating, the electret coating resulting therefrom, and the use of the electret coating for finishing textiles and carpets or for preparing filters, for example, for air and water fitration, or in cigarette filters, sensors, condenser microphones, data memories or membranes.

As can be seen from DE 10 2004 060 593 A1, electret filters are usually prepared by applying an electretable substance to the support material, melting it and charging it in an electric field.

From U.S. Pat. No. 5,191,905 A, a cigarette filter is known in which magnetic fibers and electret fibers are used for filtering fine dust.

U.S. Pat. No. 5,162,608 A describes a printing roll with an electret coating that comes into contact with a developer substance containing magnetic particles.

U.S. Pat. No. 4,258,730 A describes a coat for a cigarette filter including a switch with an electret body and a magnetic body for improving the efficiency of the cigarette filter,

JP 08038934 A relates to an air filter in which a mixture of different powders is filled into a container. A very small contact area of the electret material with the inflowing air is obtained thereby. Since only a few electret particles are directly at the surface of the filter, only a very small fraction of the electret particles can be charged with a maximum voltage. With the material described herein, a two-dimensional finish is not possible.

In most of these embodiments, the magnetic and electret components act from different directions on the same particles to be filtered. In addition, the electret materials known from the above mentioned prior art, especially if present as fibers, can usually be charged with a voltage of at most 500 V. Therefore, such materials quickly become inefficient, even if the charge is dissipated slowly.

Thus, it is the object of the present invention to enable the action of a magnetic material and electret material from the same spatial direction, and to be able to charge the electret material with as high a voltage as possible.

In a first embodiment, this object of the invention is achieved by an aqueous electret finish characterized by containing ferromagnetic particles in an amount within a range of from 0.01 to 6% by weight and particles of electret material in an amount within a range of from 0.1 to 60% by weight.

High contents of particles in the electret finish according to the invention are particularly suitable for preparing electret membranes.

Advantageously, however, the electret finish according to the invention contains ferromagnetic particles in an amount within a range of from 0.01 to 1% by weight and electret material in an amount within a range of from 0.1 to 10% by weight Low contents of particles in the electret finish according to the invention are particularly suitable for textile finishing or for the finishing or preparation of filters, for example, air and liquid filters or cigarette filters, sensors, condenser microphones or data memories.

“Ferromagnetic particles” within the meaning of the invention are advantageously particles having a magnetic susceptibility at 25° C. of at least 0.1. In addition, “ferro-magnetic particles” within the meaning of the invention is supposed to include particles that are antiferromagnetic or ferromagnetic or have ferromagnetic domains, i.e., although the domains as such are ferromagnetic by themselves, the magnetic moments of the domains have different directions and thus wholly or partially cancel out, so that no magnetic moment, or only a weaker one, can be measured from outside. An “electret material” within the meaning of the invention is a material that is dielectric and may have a permanent electric dipole moment.

The “aqueous finish” within the meaning of the invention advantageously includes any finishes that contain water. Preferably, at least 20% by weight of water is contained. Preferably, additionally to or instead of water, solvents may be contained, especially those that form a homogeneous phase with water. These include preferably ether, acetone, alcohols, such as ethanol, methanol, isopropanol.

Advantageously, usual additives, such as binders and dispersing aids, are contained, but more preferably at not more than 5% a by weight.

The magnetic susceptibility of the ferromagnetic particles is advantageously at least 1 at 25° C. Many particles that migrate through the electric field generated by the electret material carry an electric charge. If an electric charge is moved, a magnetic field that can interact with the magnetic field of the magnetic pigments is generated in addition to the electric field. Thus, for example, fine dust is deposited substantially more efficiently by the presence of ferromagnetic particles as compared to known filter materials.

The ratio of width to length of the ferromagnetic particles, or aspect ratio, is preferably within a range of from 0.5 to 2. Thus, the ferromagnetic particles have a higher mechanical stability as compared to particles having a more elongate shape, such as fibers.

The mean particle diameter of the ferromagnetic particles is preferably within a range of from 5 to 50,000 nm, especially within a range of from 10 to 200 nm. This enables a more homogeneous distribution of the particles in the electret coating resulting therefrom, and application thereof in a lower layer thickness.

It is particularly preferred for ferromagnetic particles to be present in the electret finish within a range of from 0.1 to 0.5% by weight. Similarly, it is particularly preferred for the particles of electret material to be present in the electret finish within a range of from 0.6 to 30% by weight.

The aqueous electret finish according to the invention is preferably in the form of a dispersion, especially suspension. A particularly uniform distribution of the particles in the resulting electret coating can be ensured thereby.

The ferromagnetic particles preferably consist of a material selected from the group consisting of iron, cobalt, nickel, Fe₂O₃, Fe₃O₄, CrO₂, barium ferrite, gadolinium, dysprosium, holmium, erbium, terbium, Al—Ni—Co alloy, Sm—Co alloy, Nd₂Fe₁₄B, Ni—Fe alloy, Ni—Cu—Co alloy, manganese arsenide, europium oxide, rare earth metal alloy, permalloy, silicon iron, Mn—Zn ferrites, supermalloy, barium oxide, Nd—Fe—B alloy or a mixture thereof.

The electret material is preferably inorganic or organic in nature, especially selected from the group consisting of methylsiloxane, fluoroalkylsilane, fluoropolyurethane, fluoropolyacrylate, polytetrafluoroethylene, polytetrafluoroethylenepropylene, polypropylene, polyethylene terephthalate, polyvinylidene fluoride, copolymers of the above mentioned polymers, silicon dioxide, silicon nitride, barium titanate or carnauba wax.

Even more preferably, the electret material is fluorine-containing or non-fluorine-containing polymers, such as Baygard AFF® of Lanxess AG, fluorine-containing or non-fluorine-containing acrylic polymers or copolymers, such as Dicrylan® AC of the company Huntsman Textile Effects, fluorine-containing or non-fluorine-containing polyurethanes, such as Alberdingk® U2101 of the Alberdingk Boley GmbH, fluorine-containing or non-fluorine-containing polyethylene, such as Permanol® HDL of the Dick Peters B.V., or fluoroalkylsilanes or salts thereof, such as Dynasilan® F8815 of the Degussa AG.

The water content of the aqueous electret finish according to the invention is preferably within a range of from 65.0 to 99.9% by weight, more preferably within a range of from 90.0 to 99.8% by weight. The solids content is preferably within a range of from 0.1 to 10% by weight.

In another embodiment, the object of the invention is achieved by a process for preparing an electret coating, characterized in that the electret finish according to the invention is applied to a substrate in a first step, and the substrate is dried first and then charged in an electric field in a subsequent step.

Charging during the drying process is particularly disadvantageous at least at the beginning of the drying process, because the water practically prevents charging.

By the process according to the invention and in contrast to the prior art, magnetic components and electret components can be positioned for the first time in such a way that they can act on particles substantially from the same direction. Thus, moving electrically charged particles, which thereby obtain a magnetic moment as well, can be attracted particularly effectively, since the electric field and the magnetic field can act from the same direction. The electret coating can be charged with particularly high voltages by the process according to the invention. Thus, the voltage is advantageously at least 0.5 kV, in particular, the voltage is within a range of from 5 to 1000 kV, especially within a range of from 10 to 50 kV. Surprisingly, it has further been found that coatings prepared by the process according to the invention have a charge conservation that is substantially improved over that of the prior art.

The substrate is advantageously a non-woven or glass. Also, plastic surfaces or yarns may be treated, for example.

For removing the water, the electret coating is dried preferably at a temperature within a range of from 80 to 200° C., more preferably within a range of from 120 to 140° C. The duration of the drying step is preferably within a range of from 1 to 30 min, more preferably within a range of from 5 to 15 min.

The electret finish according to the invention is preferably applied to the substrate by spraying, dipping, padder application or knife coating.

In another embodiment, the object of the invention is achieved by an electret coating on a substrate, characterized by including ferromagnetic particles.

In addition to optional usual additives, such as binders, dyes or similar components, preferably from 1 to 20% by weight of ferromagnetic particles and preferably from 80 to 99% by weight of electret material are contained in the coating.

Advantageously, the electret coating according to the invention is obtained by the process according to the invention using the aqueous electret finish according to the invention.

Preferably, the ferromagnetic particles are essentially embedded in the electret material in the electret coating according to the invention. Within the meaning of the invention, the ferromagnetic particles are “embedded” if advantageously at least 80% of the surface of the ferromagnetic particles, especially at least 90% by weight of the ferromagnetic particles, is in direct contact with electret material to at least 80%, especially at least 90%.

Preferably, the particles of electret material and the ferromagnetic particles are as described above for the electret finish according to the invention. In particular, this applies to the materials, aspect ratios, particle diameters and magnetic susceptibility.

The layer thickness of the electret coating according to the invention is preferably within a range of from 0.1 to 100 μm, especially within a range of from 1 to 30 μm.

In another embodiment, the object of the invention is achieved by the use of the electret coating according to the invention for the finishing of textiles and carpets, or for preparing filters, for example, for air and water filtration, or in cigarette filters, sensors, condenser microphones, data memories or membranes.

### EXAMPLES

A commercially available polyester spun-bonded web having a base weight of 300 g/m² and a thickness of 4 mm and an air permeability according to DIN EN ISO 9237 of 1250 l/dm²·min (±20%) was employed as the substrate. Unless stated otherwise, the polymer dispersions were about 50% (by weight) in demineralized water. The magnetic pigment was dispersed as a powder or as a dispersion usually either in the polymer dispersion or directly in demineralized water.

The aqueous electret finish was applied to the polyester spun-bonded web by spraying and subsequently dried at about 130° C. for about 10 min. After drying, the sprayed substrate was in direct neighborhood to a charging electrode R23 ATR with a high voltage generator KNH 124 of the Eltex Elektrostatik GmbH with a voltage of 20 kV, whereby the surface charging could be induced in the coating. The measuring of the surface charge was performed by means of an induction field measuring device KNH 34 of the Eltex Elektrostatik GmbH at certain intervals. The measuring of the improved filtering action was performed by means of a filter test bench of the company Palas, wherein the degree of fraction separation according to Palas was measured as a function of particle size in μm. The inflow velocity was usually 25 cm/s, and the dust load was about 200 mg/cm³ of SAE fine dust.

The following 11 electret finishes were accordingly applied to non-woven substrates, dried and charged in an electric field, wherein all the compositions were filled up to 100 parts by weight with demineralized water if necessary:

### Example 1

Two parts by weight of aqueous fluoropolymer dispersion Baygard AFF® of the Lanxess AG was dispersed in demineralized water with 0.5 part by weight of an aqueous dispersion of magnetic iron oxide pigment having a particle size of about 30 nm of the company Bühler AG, Switzerland, MK 06/D12. The dispersion could be applied by the above process, and after drying, the surface could be charged as described.

### Example 2 (Comparative Example)

0.5 part by weight of an about 20% aqueous dispersion of the magnetic iron oxide pigment from Example 1 was diluted with demineralized water and sprayed onto the substrate surface. The drying and charging was performed as described above.

### Example 3 (Comparative Example)

0.5 part by weight of an about 20% aqueous dispersion of the non-magnetic iron oxide pigment having a particle size of about 30 nm of the Bühler AG, Switzerland (V306 MP) was dispersed in demineralized water and sprayed onto the substrate surface. The adhesion without a binder is based on the electrostatic interaction between the fiber surface and the particles. The drying and charging was performed as described above.

### Example 4

Two parts by weight of an aqueous acrylate dispersion Dycrylan AC® of the Huntsman Textile Effects GmbH was dispersed in demineralized water with 0.5 part by weight of an about 20% aqueous dispersion of a magnetic iron oxide pigment coated with SiO₂ having a particle size of <1 μm of the Degussa AG. The dispersion could be applied by the above processes, and after drying, the surface could be charged as described.

### Example 5

Two parts by weight of an aqueous fluoropolymer dispersion Baygard AFF® of the Lanxess AG was dispersed in demineralized water with 0.1 to 0.5 part by weight of an about 20% aqueous dispersion of a globally non-magnetic iron oxide pigment, but which has ferromagnetic domains, and having a particle size of about 30 nm of the company Bühler AG, Switzerland (V306MP). The dispersion could be applied by the above processes, and after drying, the surface could be charged as described.

### Example 6

Two parts by weight of an aqueous polyurethane dispersion Alberdingk U 2101® of the Alberdingk Boley GmbH was dispersed in demineralized water with 0.5 part by weight of an about 20% aqueous dispersion of the magnetic iron oxide pigment from Example 1. The dispersion could be applied by the above processes, and after drying, the surface could be charged as described.

### Example 7

Two parts by weight of an aqueous polyethylene dispersion Permanol HDL® of the company Dick Peters B.V., Netherlands, was dispersed in demineralized water with 0.5 part by weight of an about 20% aqueous dispersion of the magnetic iron oxide pigment having a particle size of about 30 nm of the company Bühler AG, Switzerland. The dispersion could be applied by the above process, and after drying, the surface could be charged as described.

### Example 8

0.5 part by weight of the fluoroalkylsilane Dynasilan F 8261 of the company Degussa AG was dissolved in about 70 parts by weight of isopropanol and mixed with about 30 parts by weight of demineralized water and hydrolyzed with 0.05 part by weight of sulfuric acid with stirring. When the solution was clear again, 0.5 part by weight of an about 20% aqueous dispersion of the magnetic iron oxide pigment from Example 1 could be added. The dispersion could be applied by the above processes, and after drying, the surface could be charged as described.

### Example 9

Three parts by weight of the amino-functional fluoroalkylsilane (Dynasilan F 8815®) was dissolved in demineralized water, and the pH was adjusted to 5 with formic acid. To this solution, 0.5 part by weight of an about 20% aqueous dispersion of the magnetic iron oxide pigment from Example 1 could be added. The dispersion could be applied by the above processes, and after drying, the surface could be charged as described.

### Example 10

Two parts by weight of an about 60% aqueous emulsion of polyhydrogenmethylsiloxane Perlite SI-SW® could be added with 0.5 part by weight of an about 20% aqueous dispersion of the magnetic iron oxide pigment having a particle size of about 30 nm of the company Bühler AG, Switzerland. The dispersion could be applied by the above process, and after drying, the surface could be charged as described.

### Example 11

Two parts by weight of an aqueous fluoropolymer dispersion Baygard AFF® of the Lanxess AG was dispersed in demineralized water with 0.5 part by weight of a magnetic iron oxide pigment powder, Magnetpigment 346 of the BASF AG, having a particle size of <1 μm. The dispersion could be applied by the above process, and after drying, the surface could be charged as described.

### REFERENCE EXAMPLE

Two parts by weight of an aqueous fluoropolymer dispersion Baygard AFF® of the Lanxess AG was dispersed in demineralized water. The dispersion could be applied by the above process, and after drying, the surface could be charged as described.

Charge Conservation in Different Application Examples (Polyester Spun-Bonded Web):

| Application Example | Surface charge after 2 weeks [kV] |
|---|---|
| untreated, not charged | 0 |
| untreated, charged | 0.6 |
| Reference Example | 2.5 |
| Application Example 1 | 7.5 |
| Application Example 2 | 1.5 |
| Application Example 3 | 0.1 |
| Application Example 4 | 4.5 |
| Application Example 5 | 14 |
| Application Example 11 | 10 |

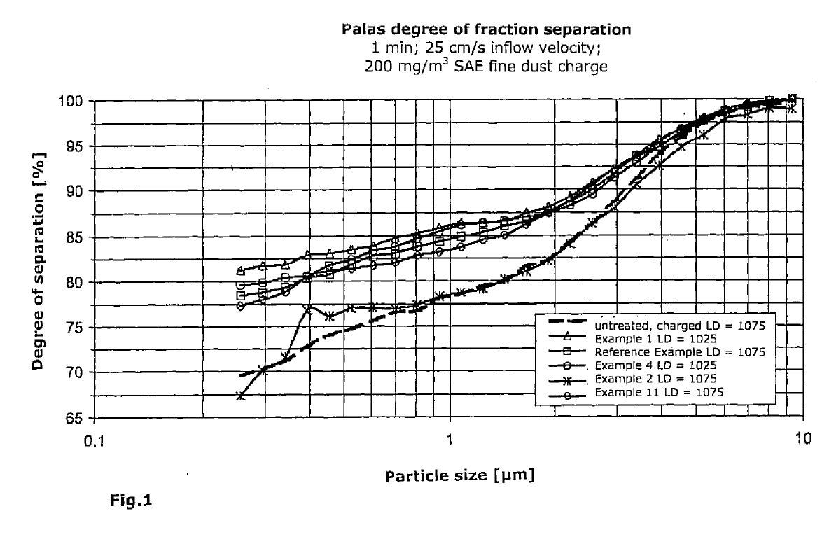

FIG. 1 shows the degree of fraction separation according to Palas after 1 min of filtration time.

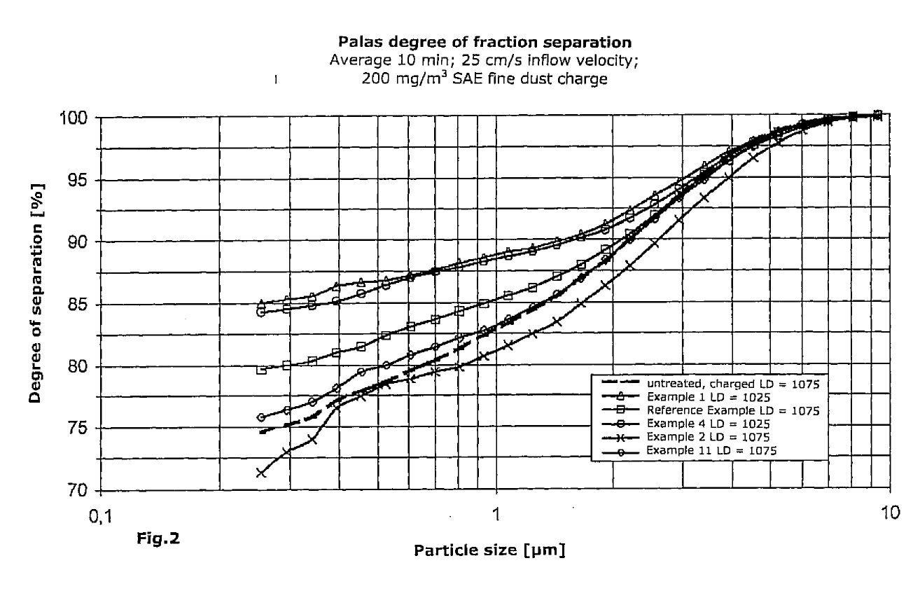

FIG. 2 shows the degree of fraction separation according to Palas after 10 min of filtration time.

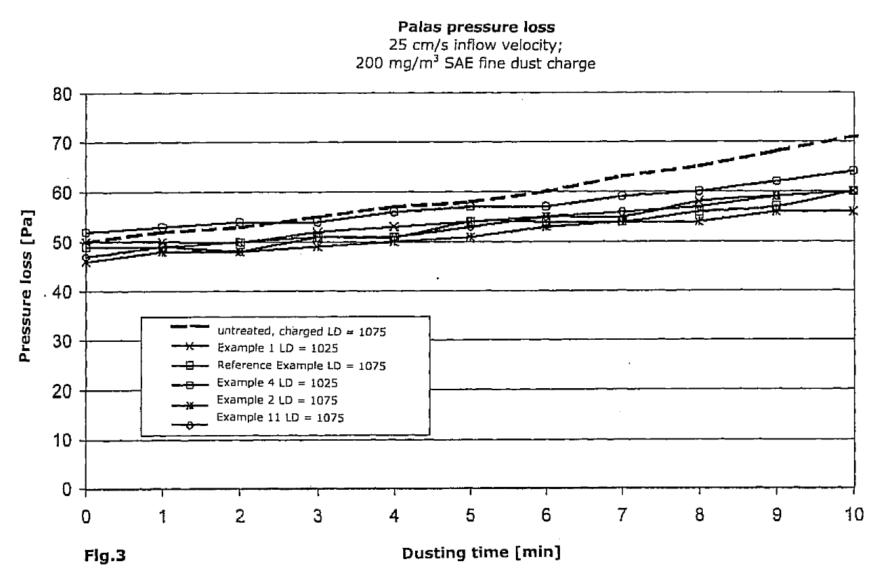

FIG. 3 shows the pressure loss as a function of dusting time.

1. A dispersed electret finish characterized by containing ferromagnetic particles in an amount within a range of from 0.01 to 6% by weight and electret material in an amount within a range of from 0.1 to 60% by weight.

2. The electret finish according to claim 1, characterized in that the material of the ferromagnetic particles has a magnetic susceptibility at 25° C. of at least 0.1.

3. The electret finish according to claim 1, characterized in that the ratio of width to length of the ferromagnetic particles is within a range of from 0.5 to 2.

4. The electret finish according to claim 1, characterized in that the mean particle diameter of the ferromagnetic particles is within a range of from 5 to 50,000 nm.

5. The electret finish according to claim 1, characterized in that the amount of electret material contained exceeds that of the ferromagnetic particles by at least 20% by weight.

6. The electret finish according to claim 1 in the form of an aqueous dispersion.

7. A process for preparing an electret coating, characterized in that the electret finish according to claim 1 is applied to a substrate in a first step, dried, and the substrate is charged in an electric field in a subsequent step.

8. The process according to claim 7, characterized in that the voltage employed for generating the electric field is within a range of from 10 to 50 kV.

9. An electret coating on a substrate, characterized by containing ferromagnetic particles.

10. The electret coating according to claim 9, characterized in that said ferromagnetic particles are essentially embedded in the electret material.

11. Use of the electret coating according to claim 10 for finishing textiles and carpets or for preparing filters, for example, air and liquid filters or cigarette filters, sensors, condenser mnicrophones, data memories or membranes.
